(19) United States
(12) Patent Application Publication
(10) Pub. No.: US 2022/0067795 A1
(43) Pub. Date: Mar. 3, 2022

(54) Method And System For Managing Communities Search Platform

(71) Applicant: Eli KEN-DROR, Batzra (IL)

(72) Inventor: Eli KEN-DROR, Batzra (IL)

(21) Appl. No.: 17/464,287

(22) Filed: Sep. 1, 2021

Related U.S. Application Data
(60) Provisional application No. 63/073,086, filed on Sep. 1, 2020.

(51) Int. Cl. G06Q 30/02; G06F 16/9536; G06Q 50/00

(52) U.S. Cl. CPC G06Q 30/0277; G06F 16/9536; G06Q 50/01; G06Q 30/0214; G06Q 30/0247

(57) ABSTRACT

The present invention provides a computerized communities search platform, comprised of
Community builder module for configuring new community group determining a default search engine and business parameters; wherein the community group is defined based on social relation, business relation, geographical relation
Monitoring communications search for aggerating users queries and search processing parameters; selections
Monetizing community module for accumulating and analyzing advertising revenue based on user's behavior while surfing through the determined default search engine

wherein all search of community members are by default performed at the determined search engine and all community member monetizing activity is aggregated to benefit a predefined financial entity where the entity include at least one of: group of people, philanthropic entity or individual.

### TECHNICAL FIELD

The present invention relates to the field of a computerized communities search engine, and more particularly, to sharing of search platforms for monetization and e commerce following platform.

### BACKGROUND ART

### SUMMARY OF INVENTION

The present invention provides a computerized communities search platform, comprised of:
Community builder module for configuring new community group determining a default search engine and business parameters; wherein the community group is defined based on social relation, business relation, geographical relation
Monitoring communications search for aggerating users queries and search processing parameters; selections
Monetizing community module for accumulating and analyzing advertising revenue based on user's behavior while surfing through the determined default search engine
   wherein all search of community members are by default performed at the determined search engine and all community member monetizing activity is aggregated to benefit a predefined financial entity where the entity include at least one of : group of people, philanthropic entity or individual.
   According to some embodiments of the present invention the Monetizing community module further accumulating and analyzing affiliates revenue based on users behavior while browsing affiliates websites/apps
   The present invention provides a computerized communities search platform, comprised of:
Community builder module for configuring new community group determining search engine and business parameters;
Monitoring communications search for aggerating users queries and search processing parameters; selections
Community analysis behavior module for identifying common queries of different users
Search enhancement module for Providing enhanced search queries based on community queries in the default search engine or from another search engine, presenting the other search engine results as a comment/review/text/multimedia/icon on top of the default search engine

The present invention provides a computenzed communities E Commerce community purchasing platform, comprised of:
E Commerce community module for identifying purchase of at last one user of products or services online and allowing community members which are registered to follow the user to buy the same products as at the same commercial terms of the first user.

The present invention provides a computerized communities search platform, implemented by one or more processors operatively coupled to a non-transitory computer readable storage device, which comprise the module of:
Community builder module for configuring new community group determining a default search engine and business parameters; wherein the community group is defined based on social relation, business relation, geographical relation
Monitoring communications search module for aggerating users queries and search processing parameters and selections;
Monetizing community module for accumulating and analyzing advertising revenue based on user's behavior while surfing through the determined default search engine;

wherein all search of community members are by default performed at the determined search engine and all community member monetizing activity is aggregated to benefit a predefined financial entity where the entity include at least one of: group of people, philanthropic entity or individual.

According to some embodiments of the present invention the Monetizing community module further accumulating and analyzing affiliates revenue based on users behavior while browsing affiliates websites/apps.

According to some embodiments of the present invention the platform further comprising:
An E-Commerce community module for identifying purchase of at last one first user of products or services online and allowing community members second user which are registered to follow the user to buy the same products as at the same commercial terms of the first user

According to some embodiments of the present invention the second user entrust deposit of predefined amount to enable automatic purchase based on first user transactions.

According to some embodiments of the present invention the platform further comprising the analyzing behavior module configured to apply at least on of the following steps:
i. Analyzing search trends;
ii. Identifying common search queries of different users;
iii. Analyzing statistics of configured affiliates links & cashback/affiliate partners/coupons/deals and platform sellers (internal platform shops);
iv. Analyzing user commercial behavior and identifying common providers of user community members;

According to some embodiments of the present invention the platform further comprise a community app store and is configured to determine plugin/extension/app of specific topics for adding services from community app store;

According to some embodiments of the present invention the monitoring communications search module further apply on of the following steps:
Monitoring and aggregating all search queries of all community members, the queries may be organized based on tags or category available for relevant search;
Monitoring and aggregating community members selections of affiliates links;
Monitoring and aggregating community members selection within search results and optionally tracking time spent at each result;
Monitoring and aggregating and associating community members comments and/or reviews to specific search results;

According to some embodiments of the present invention the platform further comprising the step of providing retroactive Cashback or discount based on future people buying the same product

The present invention disclose A computerized communities search method implemented by one or more processors operatively coupled to a non-transitory computer readable storage device, on which are stored modules of instruction code that when executed cause the one or more processors to perform the steps of:
configuring new community group determining a default search engine and business parameters; wherein the community group is defined based on social relation, business relation, geographical relation
Monitoring communications search for aggerating users queries and search processing parameters; selections
Monetizing community by accumulating and analyzing advertising revenue based on user's behavior while surfing through the determined default search engine

wherein all search of community members are by default performed at the determined search engine and all community member monetizing activity is aggregated to benefit a predefined financial entity where the entity include at least one of: group of people, philanthropic entity or individual.

According to some embodiments of the present invention the method further accumulating and analyzing affiliates revenue based on users behavior while browsing affiliates websites/apps.

According to some embodiments of the present invention, the method further comprising the step of:
identifying purchase of at last one first user of products or services online and
allowing community members a second flower user which are registered to
follow the user to buy the same products as at the same commercial terms of the first user.

According to some embodiments of the present invention the flower second user entrust deposit of predefined amount to enable automatic purchase based on first user transactions.

According to some embodiments of the present invention the method further comprising the steps of:
v. Analyzing search trends;
vi. Identifying common search queries of different users;
vii. Analyzing statistics of configured affiliates links & cashback/affiliate partners;
viii. Analyzing user commercial behavior and identifying common providers of user community members;

According to some embodiments of the present invention the method comprising the steps of plugin/extension/app of specific topics for adding services from community app store.

According to some embodiments of the present invention the monitoring further apply on of the following steps:
Monitoring and aggregating all search queries of all community members, the queries may be organized based on tags or category available for relevant search;
ix. Monitoring and aggregating community members selections of affiliates links;
x. Monitoring and aggregating community members selection within search results and optionally tracking time spent at each result;
Monitoring and aggregating and associating community members comments and/or reviews to specific search results;

According to some embodiments of the present invention the method further comprising the step of providing retroactive Cashback or discount based on future people buying the same product

### BRIEF DESCRIPTION OF DRAWINGS

FIG. 1 is a in a overview of communities search platform system architecture according to according to some embodiments of the invention;

FIG. 2 is a flow chart illustrating the community builder module according to some embodiments of the invention;

FIG. 3A is a flow chart illustrating the method of communities monitoring according to some embodiments of the invention;

FIG. 3B is a flow chart illustrating the processing of GUI search module according to some embodiments of the invention;

FIG. 4 is a flow chart illustrating the method of communities analysis module according to some embodiments of the invention;

FIG. 5 is a flow chart illustrating the communities monetizing module according to some embodiments of the invention;

FIG. 6 is a flow chart illustrating the search results enhancement modules according to some embodiments of the invention;

FIG. 7 is a flow chart illustrating the home page management module according to some embodiments of the invention;

FIG. 8 is a flow chart illustrating the 8 community reports and recommendation module according to some embodiments of the invention

FIG. 9 is a flow chart illustrating the search community page screen according to some embodiments of the invention.

FIGS. 10-12 are screen shots examples of the search community pages according to some embodiments of the invention.

FIG. 13 is screen shots examples of the search results according to some embodiments of the invention.

FIG. 14 is screen shots examples of commercial platform enabling flowers according to some embodiments of the invention;

FIGS. 15 and 16 are screen shots examples of a new tab browser presentation for users that have installed a browser extension according to some embodiments of the invention.

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

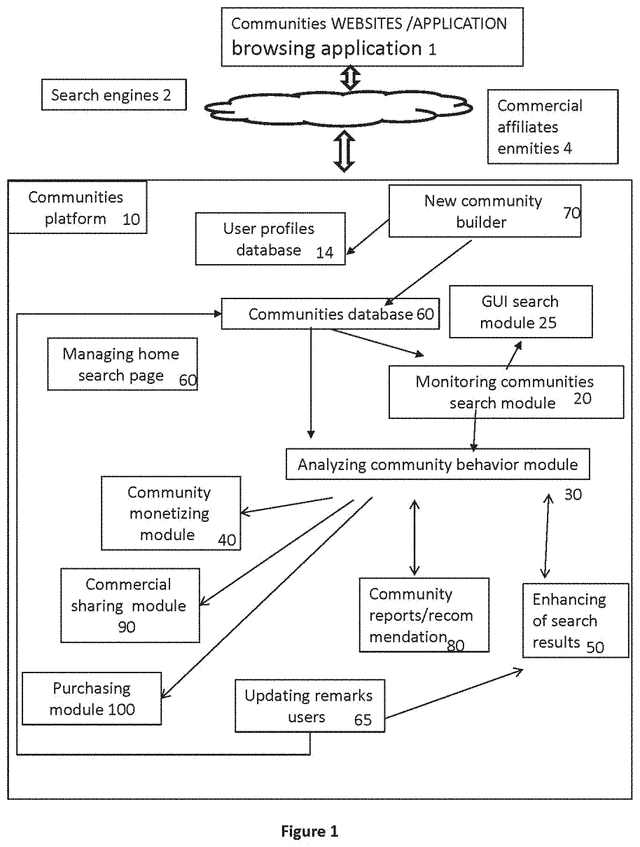

FIG. 1 is a in an overview of communities search platform system architecture according to some embodiments of the invention.

A community platform 10 is implemented on a server, enable users to create new communities which can share the same single search engine platform or results from multiple search engine platforms into another search platform when accessing the WEB, through any communication device using any browsing application 1 utilizing using predefined search engines (such as Google or Bing or others) 2. Each community can determine affiliates commercials entities such as Amazon, eBay, CJ.COM, Admitad, Awin, to enable sharing profits from commercial activity which was initiated by a community member using the community search platform. The community can define search engine 2 as default search engine for all community members, profiting from their advertising on the search engine results pages or profiting from search results such as google CSE or ads-for-search or Bing Microsoft Rewards program or Yahoo program. All this monetizing management is controlled by the community monetizing module 40. The search results of the community can be enhanced using search results enhancement module 50 by monitoring and analyzing all communities members searches and queries using monitoring 20 and analyzing 30 modules, identifying equivalent searches and sharing the search experience between the users in any kind of devices or platforms.

Community reports/recommendation 80 generates various reports of community behavior and monetization. Th user are enabled to add remarks to the search results 65, which updated in the communities database 60.

[symbol]

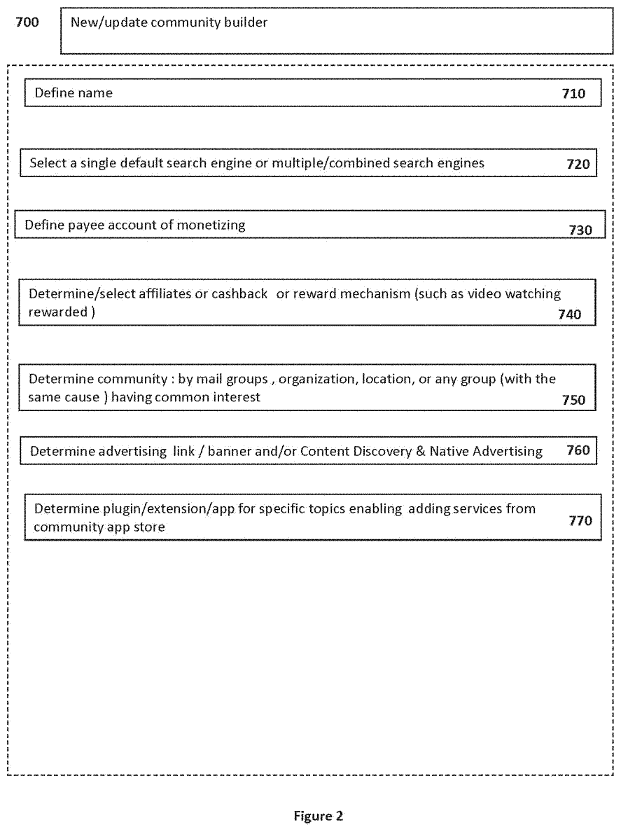

FIG. 2 is a flow chart illustrating the community builder module according to some embodiments of the invention.

The community builder module enable any group of people having common interest, such family, organization, hobby or any group having common interest (with the same cause), creating new community platform by configuring the following parameters: defining name (710); selecting a search engine or combined search engines (720); define payee account for monetizing (730); determining/selecting affiliates/cashback/reward program (740); determining community: by mail groups, organization, geographic location or any group having common interest(with the same cause) (750); Determine advertising link/banner and/or Content Discovery & Native Advertising (760); Determine plugin/extension/app of specific topics for adding services from app store/plugin power by the community (770);

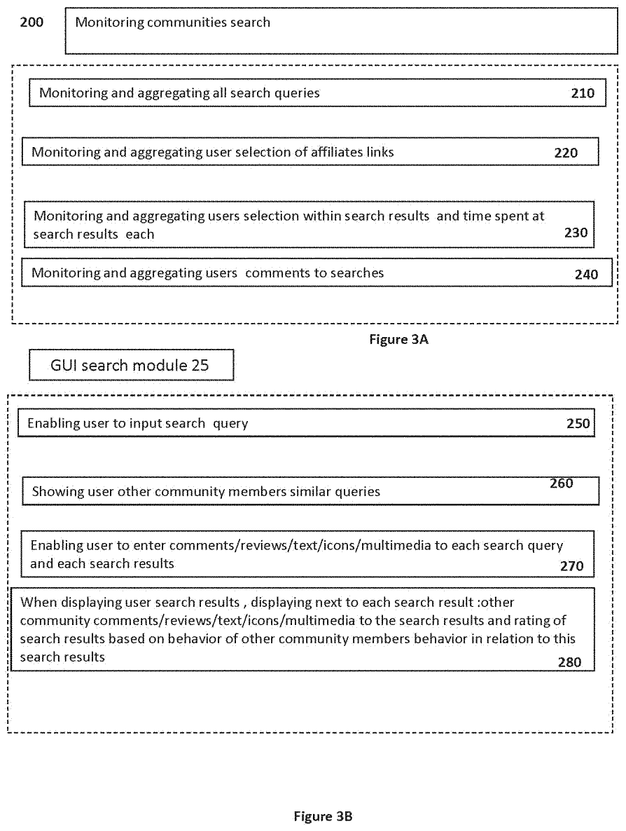

FIG. 3 is a flow chart illustrating the method of communities monitoring module according to some embodiments of the invention, The processing of monitoring apply at least one of the followings steps:
Monitoring and aggregating all search queries of all community members, the queries may be organized based on tags or category available for relevant search (step 210);
Monitoring and aggregating community members selections of affiliates links; (step 220);
Monitoring and aggregating community members selection within search results and optionally tracking time spent at each result; (step 230)
Monitoring and aggregating and associating community members comments and/or reviews to specific search results; (step 230)

FIG. 3B is a flow chart illustrating the processing of GUI search module according to some embodiments of the invention

The processing of GUI search module apply at least one of the followings steps:
Enabling user to input search query (step 250). When entering the query the designated/selected search engine of the community is applied to provide user with search results
Showing user other community members similar queries (step 260).
Enabling user to enter comments/reviews/text/icons/multimedia to each search query and each search results and storing search results is association with respective query and/or search result (step 270)
When displaying user search results, displaying next to each search result: other community members comments/reviews/text/icons/multimedia to the search results and rating of search results based on behavior of other community members behavior in relation to this search results;

Optionally the search results displaying order may change based on group priority, timing or any parameter that can sort displaying order

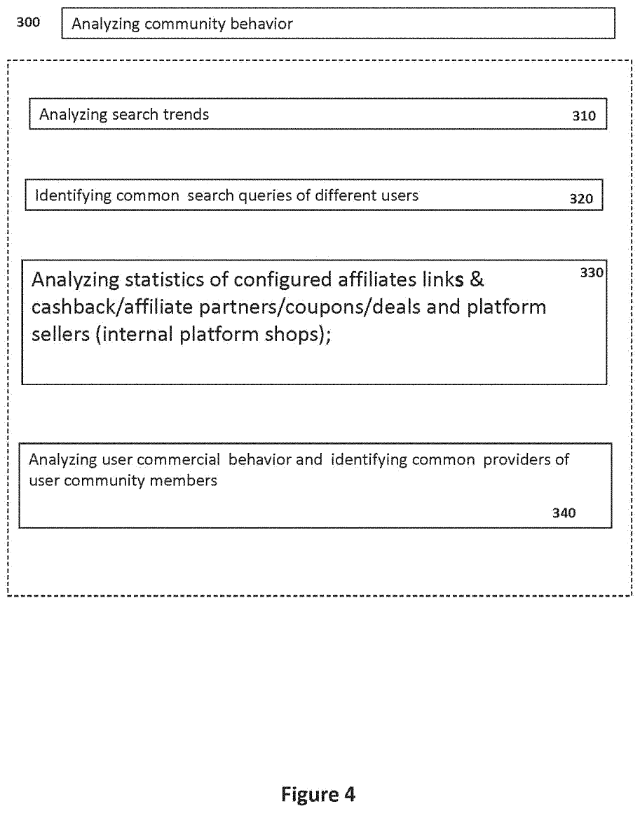

FIG. 4 is a flow chart illustrating the method of communities analysis module according to some embodiments of the invention.

The processing of communities analysis module includes at least one of the followings steps:
Analyzing search trends (step 310);
Identifying common search queries of different users (step 320);
Analyzing statistics of configured affiliates links & eashback/affiliate partners/coupons/deals and platform sellers (internal platform shops) (step 330);
Analyzing user commercial behavior and identifying common providers of user community members (step 340);

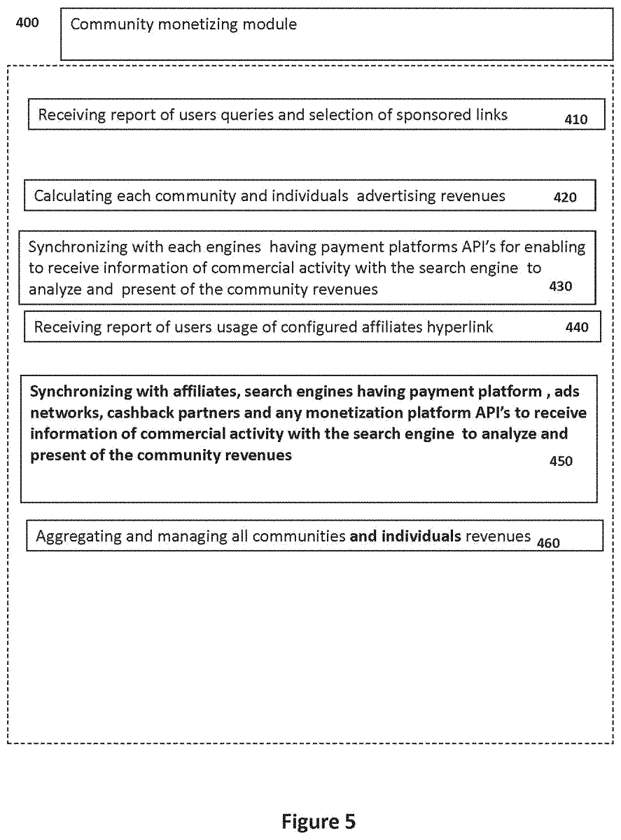

FIG. 5 is a flow chart illustrating the communities monetizing module according to some embodiments of the invention;

The processing of communities monetizing module applies at least one of the followings steps:
Receiving report of users queries and selection of sponsored links (step 410);
Calculating each community advertising revenue based on monitored user behavior, ad clicking (step 420);
Synchronizing with payed search engines API's for allowing a presentation of the community revenues (step 430);
Receiving report of users usage of configured affiliates hyperlink (step 440);
Synchronizing with affiliates, search engines having payment platform, ads networks, cashback partners and any monetization platform API's to receive information of commercial activity with the search engine to analyze and present of the community revenues (step 450);
Aggregating and managing all communities' revenues (step 460);

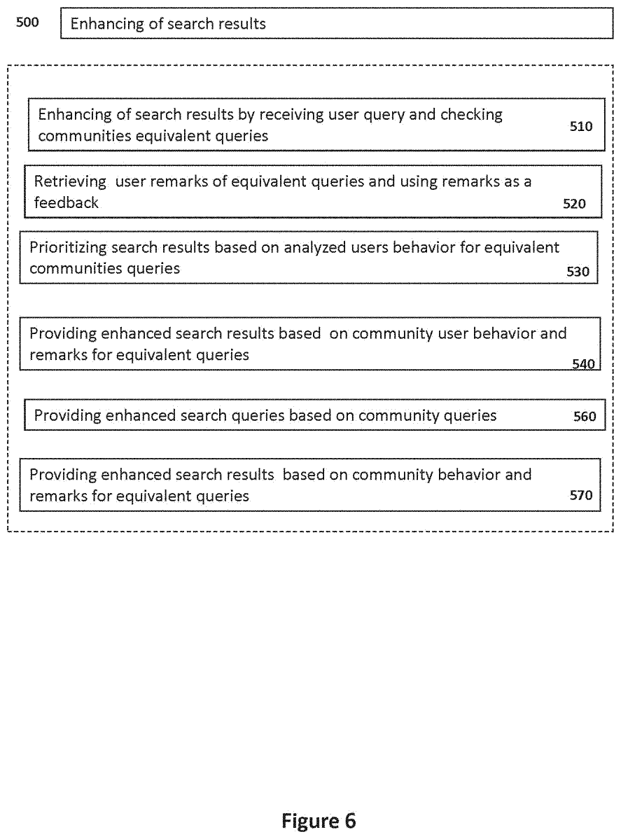

FIG. 6 is a flow chart illustrating the search results enhancement modules according to some embodiments of the invention.

The processing of search results enhancement module applies at least one of the followings steps:
Enhancing of search results by receiving user query and checking communities' equivalent queries (step 510).
Prioritizing search results based on analyzed user's behavior for equivalent queries (step 520);
Providing enhanced search results based on community user behavior and remarks for equivalent queries; (step 520);
Providing enhanced search queries based on community queries (step 530);
Providing enhanced search results based on community behavior and remarks for equivalent queries and comments for search results (step 530);
According to some embodiments of the present invention the platform allows users to share their search results with other group members or followers (users that follow their profile).

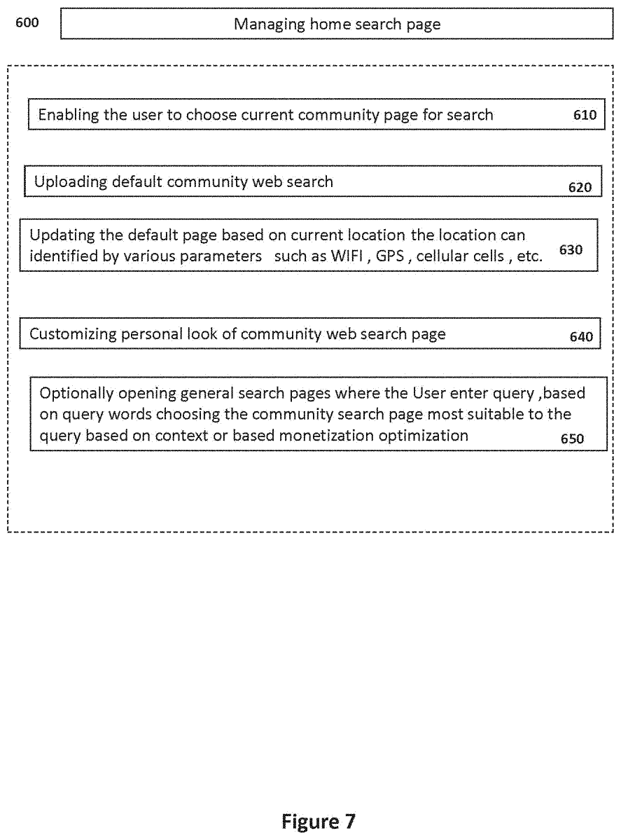

FIG. 7 is a flow chart illustrating the home page management module according to some embodiments of the invention.

The processing of communities page management module applies at least one of the followings steps:
Enabling the user to choose current community page: for search (step 610);
Uploading default community web search (step 620);
Updating the default page based on current location (step 630);
Customizing personal look of community web search page (step 640);
   Optionally opening general search pages where the User enter query, based on query words automatically choosing the community most suitable to the query based on context or based monetization optimization (step 650);

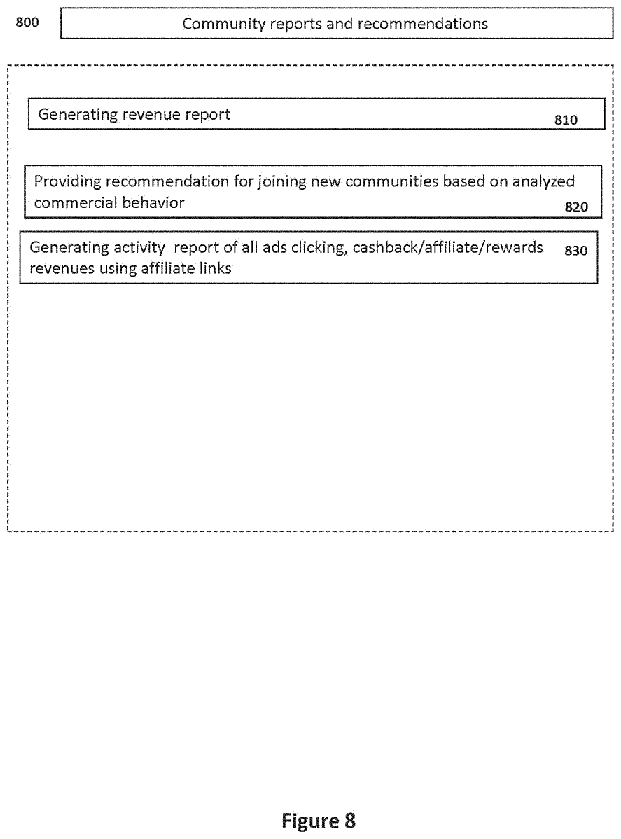

FIG. 8 is a flow chart illustrating the community reports 80 and recommendation module according to some embodiments of the invention.

The processing of community reports and recommendation module applies at least one of the followings steps:
Generating revenue report (step 810);
Providing recommendation for joining new communities based on analyzed commercial behavior (step 820);
Generating activity report of all ads clicking, cashback/affiliate/rewards revenues using affiliate links (step 830)

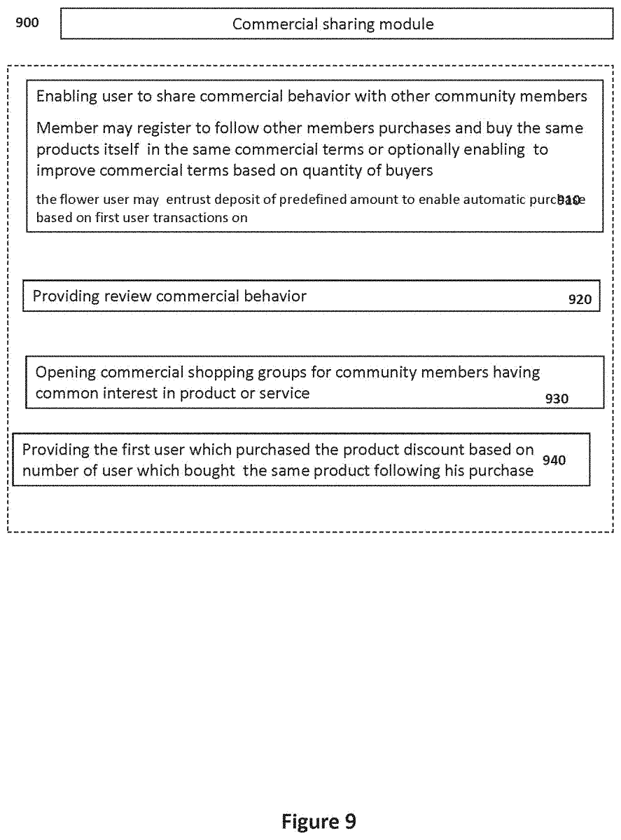

FIG. 9 is a flow chart illustrating Commercial sharing module according to some embodiments of the invention

The processing of Commercial sharing module applies at least one of the followings steps:
Enabling user to share commercial behavior with other community members
   Member may register to follow other members purchases and buy the same products itself in the same commercial terms (step 910);
Member may follow other members purchases (step 920);
Providing review commercial behavior (step 931));
Opening commercial shopping groups for community members having common interest in product or service (step 940);

The platform allows users to share their ecommerce purchases with their users and followers and allow the users/followers to join the same purchase. By joining this purchase the users will optionally gain a discount. The users will get the discount by cashback or cashback equivalent or cash or any other way.

The platform will allow users/followers to join the ecommerce purchase by push notifications (accepting to by the same product as the master user account). This can be implemented by providing and online commercial market enabling community member to share purchase and gain discounts based number of members in each group.

The platform provides a new ecommerce social platform. When a user is buying a product for $x he is joining an “After sell discount program” .incase users/followers/group members are buying the same product following his purchase then he will get a new reduced agreed price ($x-discount) based on number of members joining the.

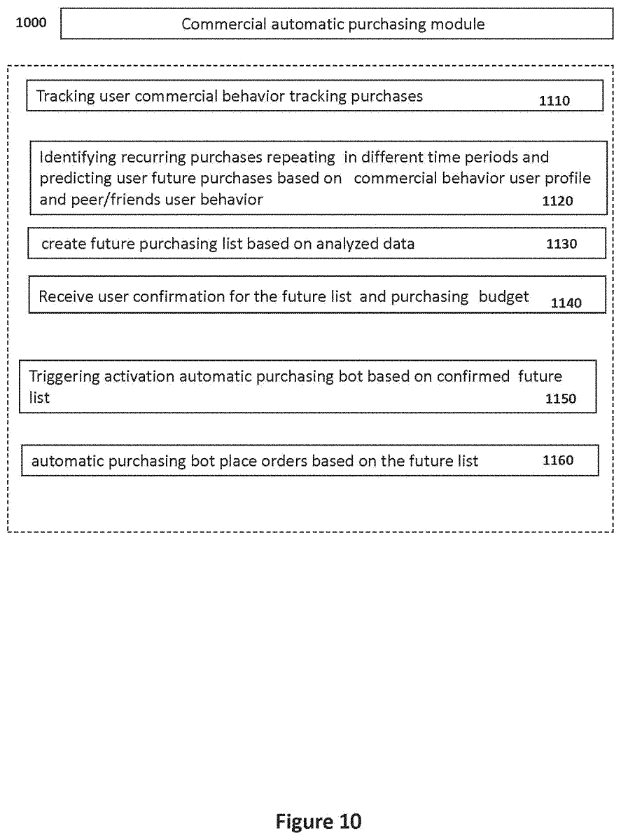

FIG. 10 is a flow chart illustrating Commercial automatic purchasing module 100 according to some embodiments of the invention
The processing of Commercial automatic purchasing module 100 includes at least one of the followings steps:
   Tracking user commercial behavior tracking purchases (1110);
   Identifying recurring purchases repeating in different time periods and predicting user future purchases based on commercial behavior user profile and peer/friends user behavior create future purchasing list based on analyzed data (step 1120);
   create future purchasing list based on analyzed data (1130);
   Receive user confirmation for the future list and budget (step 1140);
   Triggering activation automatic purchasing bot based on conformed future list (step 1150);
   automatic purchasing bot place orders based on the future list (1160);

FIG. 10 is a flow chart illustrating the search community mobile app page screen according to some embodiments of the invention.

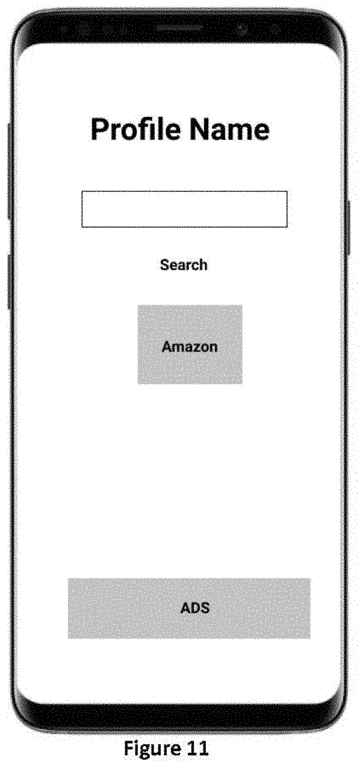

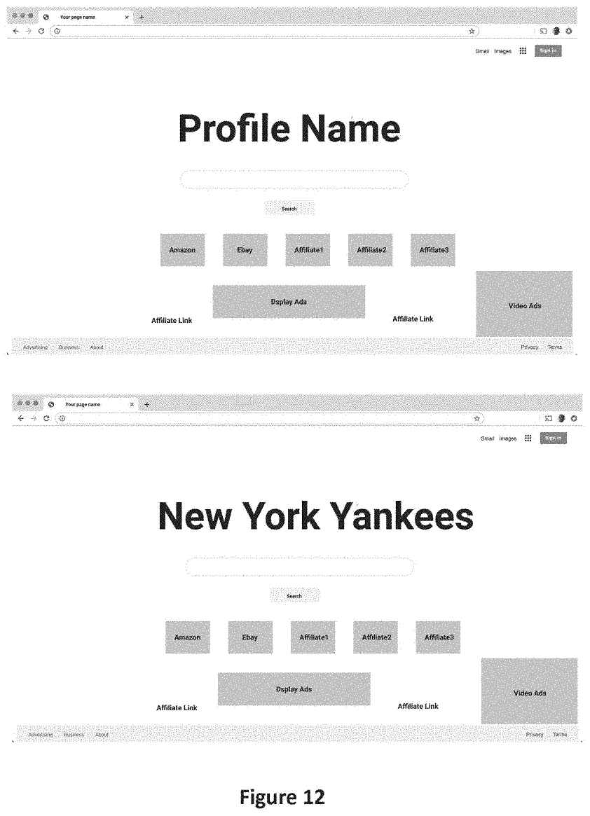

FIGS. 11-12 are screen shots examples of the search community pages according to some embodiments of the invention.

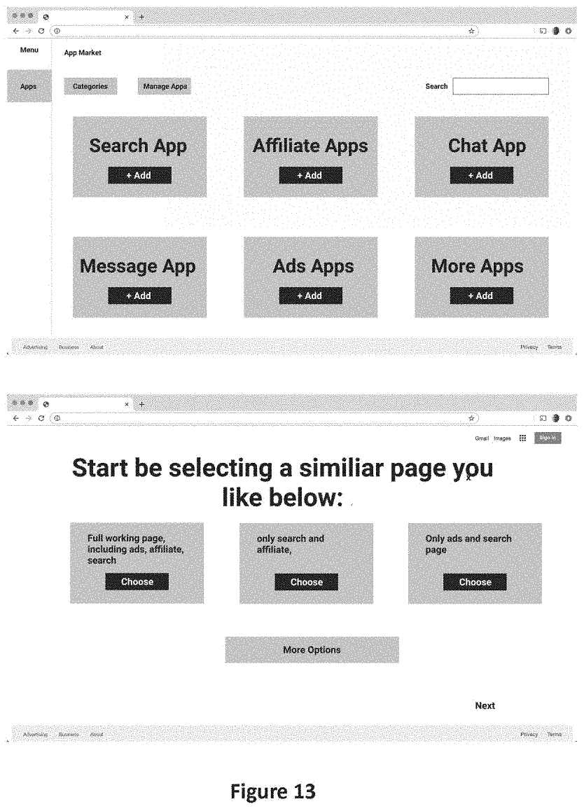

FIG. 13 is screen shots examples of the search results according to some embodiments of the invention.

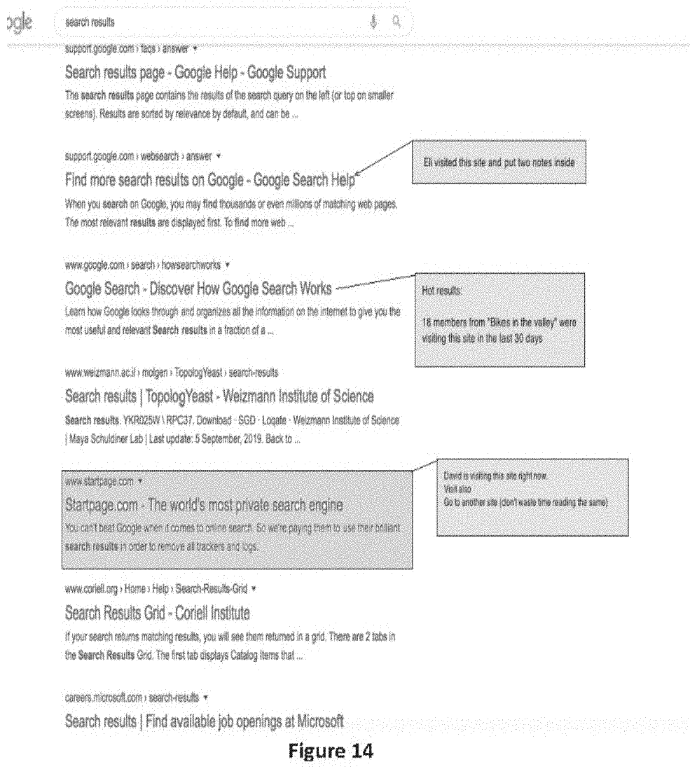

FIG. 14 is screen shots examples of commercial platform enabling to flower other community user to follow purchase of other users according to some embodiments of the invention.

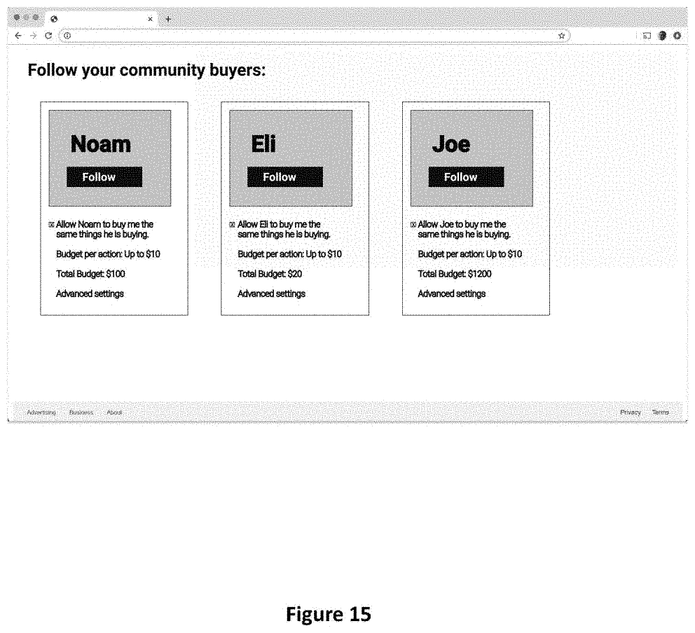

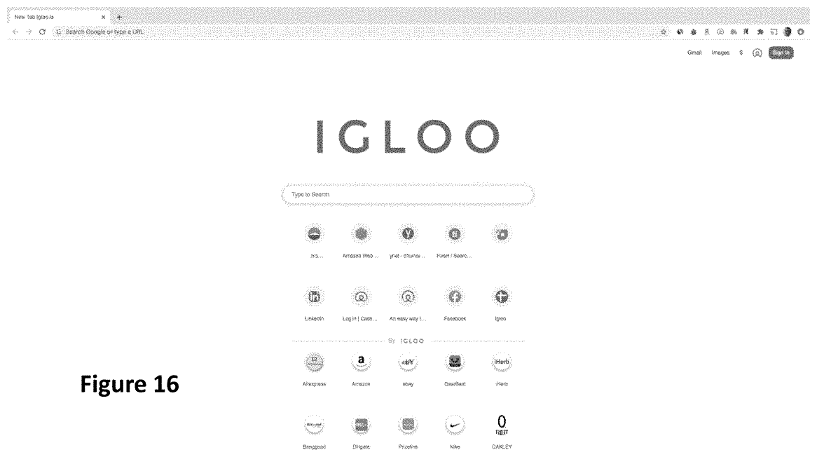

FIG. 15 is screen shots examples of a new tab browser presentation for users that have installed a browser extension according to some embodiments of the invention.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A computerized communities search platform, implemented by one or more processors operatively coupled to a non-transitory computer readable storage device, which comprise the module of:
Community builder module for configuring new community group determining a default search engine and business parameters; wherein the community group is defined based on social relation, business relation, geographical relation
Monitoring communications search module for aggerating users queries and search processing parameters and selections;
Monetizing community module for accumulating and analyzing advertising revenue based on user's behavior while surfing through the determined default search engine;
wherein all search of community members are by default performed at the determined search engine and all community member monetizing activity is aggregated to benefit a predefined financial entity where the entity include at least one of: group of people, philanthropic entity or individual.

2. The method of claim 1 wherein the Monetizing community module further accumulating and analyzing affiliates revenue based on users behavior while browsing affiliates websites/apps.

3. The platform, of claim 1 further comprising:
An E-Commerce community module for identifying purchase of at last one first user of products or services online and allowing community members second follower user which are registered to follow the user to buy the same products as at the same commercial terms of the first user.

4. The platform of claim 3 wherein the second user entrust deposit of predefined amount to enable automatic purchase based on first user transactions.

5. Then platform of claim 1 further comprising the analyzing behavior module configured to apply at least on of the following steps:
i. Analyzing search trends;
ii. Identifying common search queries of different users;
iii. Analyzing statistics of configured affiliates links & cashback/affiliate partners/coupons/deals and platform sellers (internal platform shops);
iv. Analyzing user commercial behavior and identifying common providers of user community members;

6. The platform of claim 1 wherein the platform further comprise a community app store and is configured to determine plugin/extension/app of specific topics for adding services from community app store;

7. The platform of claim 1 wherein the monitoring communications search module further apply on of the following steps:
Monitoring and aggregating all search queries of all community members, the queries may be organized based on tags or category available for relevant search;
Monitoring and aggregating community members selections of affiliates links;
Monitoring and aggregating community members selection within search results and optionally tracking time spent at each result;
Monitoring and aggregating and associating community members comments and/or reviews to specific search results;

8. The platform of claim 4 further comprising the step of providing retroactive Cashback or discount based on future people buying the same product

9. A computerized communities search method implemented by one or more processors operatively coupled to a non-transitory computer readable storage device, on which are stored modules of instruction code that when executed cause the one or more processors to perform the steps of:
configuring new community group determining a default search engine and business parameters; wherein the community group is defined based on social relation, business relation, geographical relation
Monitoring communications search for aggerating users queries and search processing parameters; selections
Monetizing community by accumulating and analyzing advertising revenue based on user's behavior while surfing through the determined default search engine
wherein all search of community members are by default performed at the determined search engine and all community member monetizing activity is aggregated to benefit a predefined financial entity where the entity include at least one of group of people, philanthropic entity or individual.

10. The method of claim 9 wherein the Monetizing community module further accumulates and analyses affiliates revenue based on users behavior while browsing affiliates websites/apps.

11. The method of claim 9 further comprising the step of identifying purchase of at last one first user of products or services online and allowing community members second flower users which are registered to follow the user to buy the same products as at the same commercial terms of the first user.

12. The method of claim 9 wherein the second flower user entrust deposit of predefined amount to enable automatic purchase based on first user transactions.

13. The method of claim 9 applying at least one of the following steps:
i. Analyzing search trends;
ii. Identifying common search queries of different users;
iii. Analyzing statistics of configured affiliates links & cashback/affiliate partners;
iv. Analyzing user commercial behavior and identifying common providers of user community members;

14. The method of claim 9 further comprising the steps of plugin/extension/app of specific topics for adding services from community app store.

15. The method of claim 9 wherein the monitoring further apply on of the following steps:
Monitoring and aggregating all search queries of all community members, the queries may be organized based on tags or category available for relevant search;
i. Monitoring and aggregating community members selections of affiliates links;
ii. Monitoring and aggregating community members selection within search results and optionally tracking time spent at each result;
Monitoring and aggregating and associating community members comments andlor reviews to specific search results;

16. The platform of claim 4 further comprising the step of providing retroactive Cashback or discount based on future people buying the same product
